(19) United States
(12) Patent Application Publication
(10) Pub. No.: US 2016/0227277 A1
(43) Pub. Date: Aug. 4, 2016

(54) METHOD AND SYSTEM FOR DETERMINING VIEWERS' VIDEO CLIP ATTENTION AND PLACING COMMERCIAL RESPONSIVE THERETO

(71) Applicant: Clickspree Performance Ltd., Raanana (IL)

(72) Inventors: Mark Nati SCHLESINGER, Raanana (IL); Ben Zion ZADIK, Shoham (IL)

(73) Assignee: Clickspree Performance Ltd., Raanana (IL)

(21) Appl. No.: 15/014,614

(22) Filed: Feb. 3, 2016

Related U.S. Application Data
(60) Provisional application No. 62/111,647, filed on Feb. 3, 2015.

(51) Int. Cl. H04N 21/442; H04N 21/431; H04N 21/81

(52) U.S. Cl. CPC H04N 21/44218; H04N 21/812; H04N 21/4312

(57) ABSTRACT

A system and method for optimizing content to be inserted into a web object. The method includes: receiving an identifier associated with the web object; determining a category of the web object; identifying focus rules respective of the determined category, wherein the focus rules indicate characteristics of the web object related to cognitive interest; analyzing, based in part on the focus rules, the web object; determining, based on the analysis, a content placement moment in the web object; and causing a placement of the content in the web object at the content placement moment.

### CROSS-REFERENCE TO RELATED APPLICATIONS

This application claims the benefit of U.S. Provisional Application No. 62/111,647 filed on Feb. 3, 2015, the contents of which are hereby incorporated by reference.

### TECHNICAL FIELD

The present disclosure relates generally to online advertising, and more particularly to enhancement of the user's attention to the advertised content.

### BACKGROUND

Websites, including commercial, corporate, and personal websites, publish advertisements on their web pages. Such advertisements are typically published in the form of a banner that may comprise static or rich media content. Banners that include rich media content are displayed as a combination of text, audio, still images, animation, video, and interactive content. Other forms of advertisements published on websites may include recommendations for content and/or calls-to-action.

Video clips embedded in webpages provide another platform for advertising content. Typically, a pre-roll video, a mid-roll video, or a banner is played or otherwise displayed prior to or during the clip that a user wishes to view. One or more static banners can be embedded in those webpages as well. However, in most cases, such banners are not associated with the content of the video clip and, more particularly, the advertised content in such banners is not updated according to the video clip's content. Generally, a static banner advertisement includes a single advertising view presented to a viewer. For example, a static banner advertisement may show a new product associated with its slogan, price, and the like.

However, such advertisements are limiting in that, even if they are designed to provide relevant information to the viewer, in most cases, they do not attract the viewers' attention to the content of the advertisement. As a prime example, video advertisements are usually skipped by viewers because the viewers simply ignore the advertised content in anticipation of the video clips they have already selected for viewing. Furthermore, a definitive number of viewers simply ignore banners displayed both inside and outside of the video clip's frame as well as in-stream banners, as such banners distract the viewers from the video's content. This ignoring results in rapid declines in pricing per one thousand pre-roll advertisements because low numbers of clicks tend to demonstrate lower value provided by such advertisements. It is an expected result rising from the facts that the advertisement often disturbs the viewer of the clip, the advertisement may appear when the viewer is not ready to pay attention to the advertisement, and the advertisement may appear at a position that is not readily visible to the viewer.

One solution for increasing the attention paid by users to displayed video advertisements is to provide the content creator or provider with the means to add interactive commentary to the displayed video. The added commentary may be a link to a website of the advertised product, background information about the video, and the like. However, the disadvantage of such a solution is that the commentary is typically edited and added prior to the publication of the video. As a result, the commentary (frequently referred to as video annotations) cannot be automatically modified based on the interaction of viewers with the displayed content. Manual modification of commentary is an expensive process and may not be feasible.

Further, video annotations cannot be optimized in real time based on, for example, interactions with the displayed video, predefined templates, and the like. The commentary is typically static and cannot be programmed. In addition, such commentary provides limited presentation possibilities. Lastly, modification of commentary is per video and, consequently, such modifications cannot be performed in bulk for groupings of video clips.

It would be advantageous to provide a solution that would overcome the deficiencies of the prior art with regard to online video advertising platforms, and more specifically that would allow advertisements to appear in a manner where they are more likely to receive the viewers' attention. It would be further advantageous if such a solution would permit minimally disruptive testing of advertisements that would permit determinations of ideal placement of advertisements within video content.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for optimizing content to be inserted into a web object. The method includes: receiving an identifier associated with the web object; determining a category of the web object; identifying focus rules respective of the determined category, wherein the focus rules indicate characteristics of the web object related to cognitive interest; analyzing, based in part on the focus rules, the web object; determining, based on the analysis, a content placement moment in the web object; and causing a placement of the content in the web object at the content placement moment.

The disclosed embodiments also include a system for optimizing content to be inserted into a web object. The system includes: a processing unit; and a memory, the memory containing instructions that, when executed by the processing unit, configure the system to: receive an identifier associated with the web object; determine a category of the web object; identify focus rules respective of the determined category, wherein the focus rules indicate characteristics of the web object related to cognitive interest; analyze, based in part on the focus rules, the web object; determine, based on the analysis, a content placement moment in the web object; and cause a placement of the content in the web object at the content placement moment.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for causing optimized placements of advertisements in video clips according to an embodiment.

FIG. 3 is a viewer attrition graph for an exemplary video clip category.

FIG. 4 is a flowchart illustrating a method for providing advertisements using category and video clip customization according to an embodiment.

FIG. 5 is a flowchart illustrating a method for providing category focus rules according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to various exemplary embodiments, a method is disclosed for displaying advertisements customized to match or otherwise compliment the content displayed in a web object. The advertisements may have an associative connection to the web object that can be derived respective of an analysis of content of the web object, including categorization of the web object, viewer retention, viewer attention, and focus. The advertisement is displayed at an appropriate time and at a predefined location with respect to the web object. A web object, as used herein, can be any object such as, for example, an image, an embedded video, a map, a slide, audio, or an embedded presentation or a podcast.

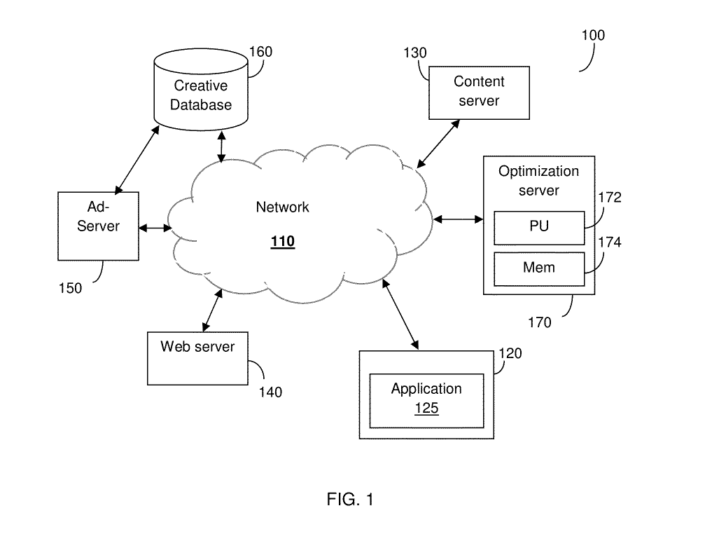

FIG. 1 shows an exemplary and non-limiting schematic diagram of a network system 100 utilized to describe the disclosed embodiments. The system 100 includes a network 110, which may be the Internet, the world-wide-web (WWW), a local area network (LAN), a wide area network (WAN), a metro area network (MAN), and the like, and which may further be wired or wireless.

As illustrated in FIG. 1, at least one user device 120, a content server 130, a web server 140, an ad-server 150, a creative database 160, and an optimization server 170 are communicatively connected to the network 110. The user device 120 may be, but is not limited to, a personal computer (PC), a personal digital assistant (PDA), a mobile phone, a smart phone, a tablet computer, a television, a wearable computing device, a laptop, and the like. The user device 120 is configured to execute at least one application 125 for downloading and displaying webpages. The application 125 can also display and play video clips embedded in web pages. In an exemplary embodiment, the application 125 is a web browser.

The web server 140 hosts one or more websites accessible through the user device 120. The content server 130 stores at least web objects to be embedded in the web pages provided by the web server 140. The content server 130 may be a server of a video sharing website (e.g., YouTube®), a dedicated content server of a content provider, and the like. In another embodiment, the content server 130 may be a CDN system utilized by video streaming services or websites, such as Netflix®, Hulu®, and the like. It should be noted that one user device 120, one application 125, one content server 130, and one web server 140 are illustrated in FIG. 1 merely for the sake of simplicity and without limitation on any of the disclosed embodiments.

According to the various embodiments, the ad-server 150 may select, define, assign, associate, and serve advertisements and other content that are customized to a web object viewed by a user of the user device. The web object may include, for example, a file, an image, a video clip, a video file, a map, text, an audio file, a slide, a media file, a multimedia file, a digital media file, a podcast, a presentation, and the like. For the sake of simplicity and without limitation on the generality of the disclosed embodiments, the web object will be referred to herein as a video clip.

The optimization server 170 is configured to retrieve and/or customize the advertisements to be served by the ad-server 150 to maximize user attention to the advertisements. In an embodiment, the optimization server 170 is configured to dynamically change advertisements throughout the playing of the video clip and to cause a display of the changed advertisements in such a time and location as to draw the most attention from the viewer.

The advertisements may further be customized to maximize viewer attention. Customizing the advertisements may include, but is not limited to, modifying an appearance method of the advertisements, determining nudge moments for the advertisements, and so on. The appearance method may be determined based on a profile of the viewer, a video frame that the advertisement is displayed in, predication in the motion detected in the clip, combinations thereof, and the like. For example, the appearance method of the advertisement may be from left-to-right if there is predicated motion of a car driving from left to right in the frames prior to displaying the advertisement. As another example, a location of the advertisement is at the right corner of the frame if there is predicated motion in or to the right corner, thereby increasing the likelihood that the attention of the viewer will be focused in that corner at that time.

The appearance method may further set the visual appearance of the advertisement based on the color schema, contrast, brightness or any other graphic elements in one or more of the video frames in which the advertisement is displayed. For example, the visual appearance of the advertisement may include a background color, a text color, font or size, an advertisement frame color, and the like. For example, for dark video frames in which the advertisement is displayed, the advertisement may be in lighter colors, thereby increasing the viewers' attention to the advertised content.

The advertisement customization may further include determining nudge moments for the advertisements. Nudge moments may be moments during which a currently displayed advertisement will be shaken, moved, or otherwise animated to draw a viewer's focus. The nudge moments may be determined based on cognitively significant moments in the video, and may be further based on the determined advertisement placement moments. As a non-limiting example, cognitively significant moments for a 2 minute video are determined to start at times: {22, 29, 31, 45, 67, 78, 86, 99, 112, and 118}. If advertisements are to be placed at times {22, 31, 67}, the nudge moments may be determined to be at times {29, 45, 99}, and the placed advertisements may be shaken at moments 29, 45, and 99, respectively.

The advertisements may include customized content such as, for example: a call-to-action, or a notice. The call-to-action, or suggestion, provided by the disclosed embodiments allows viewers who show interest in a specific web content to take a relevant action, thereby leading viewers to related content offered by the owner of the advertisement. A call-to-action may include a suggestion presented to the viewer that encourages performance of an action in the related content such as, but not limited to, buying a related product, reading another article, seeing another video, and subscribing to a newsletter or magazine. That is, in an embodiment, the advertisements' customized content includes placing the action itself (e.g., a form, a buy button, and so on) in association with displayed web content. The action is generally placed appropriately within the advertisements with respect to time such that the user response time is minimized. Therefore, the call-to-action is triggered in the best timing, thereby providing the ability to perform the desired action.

The notice includes a means of bringing a piece of information to a user's attention. When the notice is provided to the user, the user becomes more likely to pay attention to the advertisement.

In an embodiment, the customized content of the advertisements may include one or more customized advertisements including, e.g., one or more advertisement files, advertisement images, video clips, advertisement video files, text advertisements, advertisement banners, audio advertisements, and the like. The customized advertisements may be further tailored to particular viewers or groupings thereof. For example, customized advertisements presented to a user whose search history indicates an interest in playing tennis may include targeted advertisements for tennis equipment. The advertisements can also include links (URLs) to landing webpages associated with the advertiser and/or can provide additional information about the advertised content. In one embodiment, when the user clicks on a call-to-action included in the advertisement, the landing webpage will be opened and viewable in the video frame. The landing webpage can alternatively or additionally be opened at any location on the browser or as an over layer frame

The advertisement may be retrieved from external parties (e.g., ad-exchanges, advertising networks, affiliate-networks, and so on) and/or from local parties (e.g., a website or publisher affiliate that includes a webpage object). The optimization server 170 may be configured to serve customized advertisements and/or to send customized advertisements to the ad-server 150.

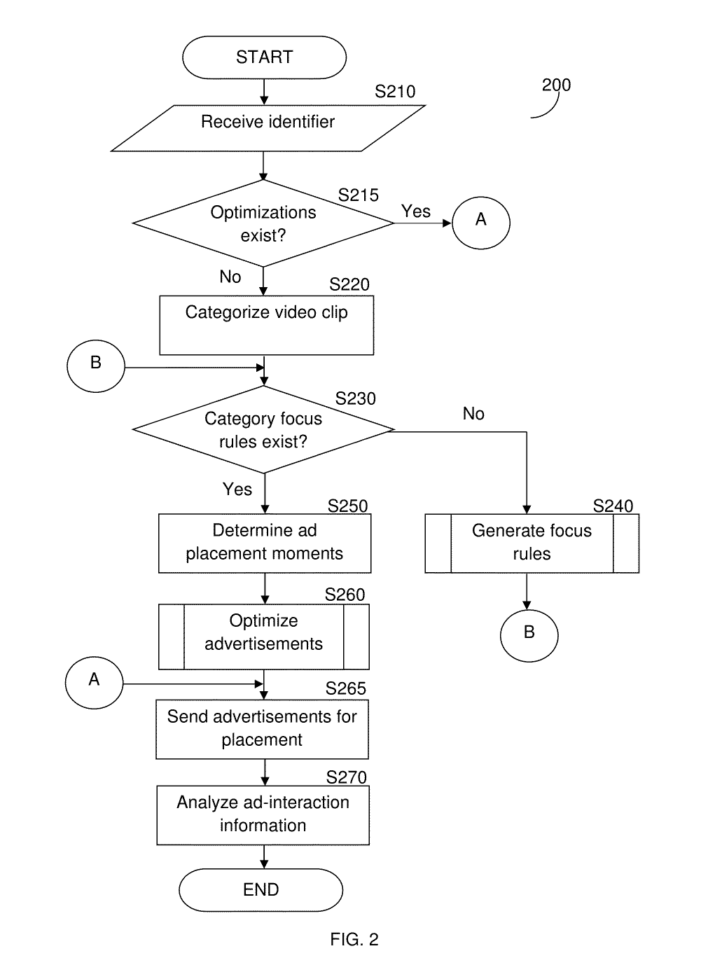

A creative database 160 is communicatively connected to the ad-server 150. The creative database 160 maintains, for each web object, a designation to display advertisements, such as one or more advertisements to be displayed along with a video clip. Specifically, each web object may be associated with one or more websites and a set of configurable ad-selection rules to provide the database mapped to the one or more advertisements. Ad-selection rules may include, but are not limited to, preferred video categories for ads, focus rules, and other parameters as described further herein below with respect to FIG. 2. The web object may be further associated with data and/or metadata resulting from the embodiments described further herein.

In a non-limiting embodiment, a media player executed on the user device 120 may be adapted or configured to include script code (e.g., JavaScript code) that would call the ad-server 150 to place an advertisement in a location and timing determined to attract the user's attention. Alternatively or collectively, the optimization server 170 may push placement information, including location and timing, to the user device 120. The location and timing are determined according to ad-selection rules and focus rules discussed in greater detail below.

In a non-limiting embodiment, the ad-selection rules may include a plurality of tags or other metadata designed to associate advertisements with video clips. The tags allow provision of advertisements customized to displayed content. A non-limiting embodiment for tagging content is disclosed in U.S. patent application Ser. No. 14/104,097, assigned to the common assignee, which is hereby incorporated by reference.

The optimization server 170 typically includes a processing unit (PU) 172 coupled to a memory (mem) 174. The processing unit 172 may comprise or be a component of a processor (not shown) or an array of processors coupled to the memory 174. The memory 174 contains instructions that can be executed by the processing unit 172. The instructions, when executed by the processing unit 172, cause the processing unit 172 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be understood that the embodiments disclosed herein are not limited to the specific architecture illustrated in FIG. 1, and other architectures may be equally used without departing from the scope of the disclosed embodiments. Specifically, the optimization server 170 may reside in a cloud computing platform, a datacenter, and the like. Moreover, in an embodiment, there may be a plurality of servers operating as described hereinabove and configured to either have one as a standby, to share the load between them, or to split the functions between them.

FIG. 2 depicts an exemplary and non-limiting flowchart 200 illustrating a method for causing optimized placement of advertisements in a video clip according to an embodiment. In an embodiment, the method of flowchart 200 may be performed by an optimization server (e.g., the optimization server 170).

In S210, an identifier of a video clip is received. The identifier may be a URL of the video clip, an identification number, and the like. In a further embodiment, the video clip identifier may only be received after the video clip has been viewed a predetermined number of times (for example, after 100 views, the video clip may be received for advertisement customization respective thereof). This viewing requirement may be utilized to prevent optimization for underperforming video clips, thereby conserving computing resources (i.e., video clips having viewership of, for example, less than 10 views may not justify the devotion of computing resources to advertisement optimization).

It should be understood that receiving may mean a push (e.g., where the video clip's identifier is sent without being specifically requested) or pull (e.g., where the video clip's identifier is intentionally accessed). In an embodiment, a piece of code, e.g., a JavaScript code, is embedded in a webpage displaying the video clip or in a video player embedded in the Java Script. The piece of code causes the video clip's identifier to be sent for analysis when, for example, the video clip is being displayed on the user device. In an embodiment, the actual video clip is sent for an analysis.

In another embodiment, identifiers of video clips are received by a crawler process configured to crawl through a website, and each identifier of a video clip encountered during the crawl is sent for analysis, for example, to the optimization server 170. In one implementation, only video clips previously viewed or currently being viewed by the viewers are sent for analysis. In a further embodiment, only video clips having been viewed above a predefined threshold may be sent for analysis. In another embodiment, it is checked if a video clip associated with a received identifier has been already analyzed, for example, by querying the optimization server 170. If so, such a video clip is not sent for analysis.

In S215, it is checked if advertisement optimizations (i.e., placement and/or customization of advertisements) have already been determined for the video clip identified by the received identifier. Such advertisement optimizations may be maintained per video clip and/or per category. If so, execution continues with S265 where optimized advertisements are sent for placement in the identified video clip; otherwise, execution continues with S220.

In S220, the video clip is categorized into one of a plurality of predetermined categories. Such categories may include, for example and without limitation, car critiques, educational clips, sport event clips, instructional clips, astronomy clips, travel clips, classical music clips, rock and roll clips, and so on. Video clips may be categorized based on, for example, video metadata, metadata associated with the webpage on which the video is hosted, a category of the webpage on which the video is hosted (e.g., sports, news, cooking, entertainment, and so on), tags, metadata, external information about the video, and so on.

In S230, it is checked if the category has a set of focus rules and, if so, execution continues with S250; otherwise, execution continues with S240. The focus rules stem from an analysis of a plurality of video clips in the determined category. It has been found that, within categories, video clips will have fairly consistent characteristics. These characteristics, when properly selected and considered, provide for an optimal prediction for appropriate placement of advertisements to ensure maximal user attention. Specifically, advertisements may be placed to minimize interruption during moments in which users are focused on the video clip and/or to maximize the likelihood that the user will focus on advertisements placed within the video clip.

The advertisement placement may be based on cognitively significant moments in the video clip related to viewer focus or disinterest such as, but not limited to, the most cognitively uninteresting moments, drop moments, completion-oriented moments, highly emotional moments, stimulus seeking moments, and other moments in which a user is focused or distracted with respect to the video clip.

The most cognitively uninteresting moments in a video clip are those moments during which the attention of the viewer is least likely to be actually paying attention to the displayed video clip. The most cognitively uninteresting moments may further include stimulus seeking moments in which viewers are known to begin seeking other stimuli. In such moments, the viewer would likely seek out or otherwise welcome cognitive stimulations. As a result, displaying advertisements in such moments would increase the viewer's attention to the advertised content.

The drop moments are moments during which a viewer completely ceases paying attention to the video clip, either consciously (i.e., the user specifically chooses to ignore the video) or unconsciously (i.e., the user unintentionally stops focusing on the video in favor of, for example, other content). Thus, a few seconds before such drop moments, the viewer will become very bored with the displayed content. Therefore, such drop moments may indicate the approach of the most cognitively uninteresting moments in a video and, accordingly, advertisements may be placed immediately after such drop moments.

The completion-oriented moments are moments in which a viewer is finished watching the video clip but has not yet stopped playing the video clip. For example, a viewer may completely cease paying attention to the video clip when credits begin rolling. In an embodiment, it may be determined that advertisement placement is not appropriate after such completion-oriented moments. In a further embodiment, one or more recommendations for additional videos may be determined and sent for placement in the completion-oriented moments.

The highly emotional moments indicate moments in which viewers are particularly focused on the video. Such moments may include, e.g., significant plot moments, main events, sports movements (e.g., a golf swing, a throw, a pass, a shoot, a pitch, a serve, etc.), sports plays (e.g., a pass and run in football), and so on. Optimal advertising placement may include placing advertisements near such highly emotional moments such that viewers are highly focused when the advertisement is displayed.

In an embodiment, the cognitively significant moments can be determined by analyzing the video and audio content of the clip with respect to transitions between video clip segments, beginnings and ends of speech, changes in the bitrate of the video, beginnings and ends of music, transitions from music to speech and vice versa, transitions from silence to noise and vice versa, relative volumes, still images within a video clip, transitions to or from a still image, high motions between frames indicating cognitive overload, cognitive boredom, scene changes, brightness, contrast, blur, combinations thereof, and so on. By using these various parameters for a collection of clips within a category, it is possible to identify commonalities or create filters within a category and further determine an appearance method for the advertisement, nudge moments for drawing more attention to the advertisement, and/or positions in which to place the advertisement into the web object at a time where the viewer's attention is more likely to be drawn thereto. New filters can be created based on machine learning processing of past behavior, for example, based on the baseline/random insertion sampling of timing.

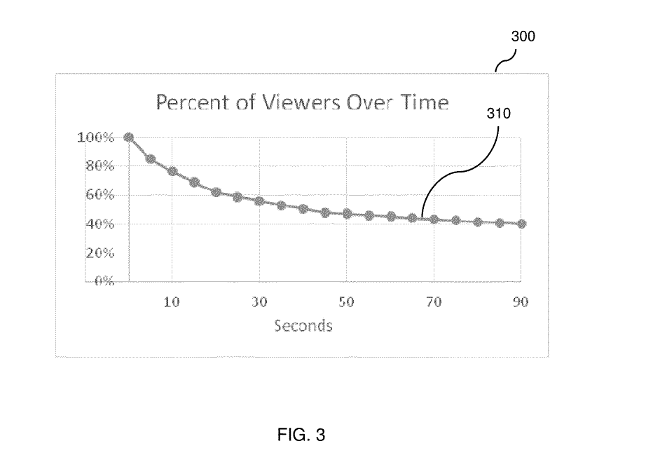

Creation of the set of rules for a category may further involve an analysis of the percentages of viewers that will drop from viewing the video clip (the attrition rate) at designated points in time. Analyzing viewer attrition rates is described further herein below with respect to FIG. 3. Alternatively or collectively, the set of rules for the category may be created based on attrition rates for video clips in similar categories and/or sub-categories. Further, the set of rules may be based on redundant portions of video clips within a category. As an example, if all video clips in a category include a common portion featuring an introductory song, viewers may be less likely to pay attention during the repeated introductory song. Moreover, the category rules may be based on typical viewer interactions with advertisements displayed respective of various moments in video clips belonging to the category and/or similar categories.

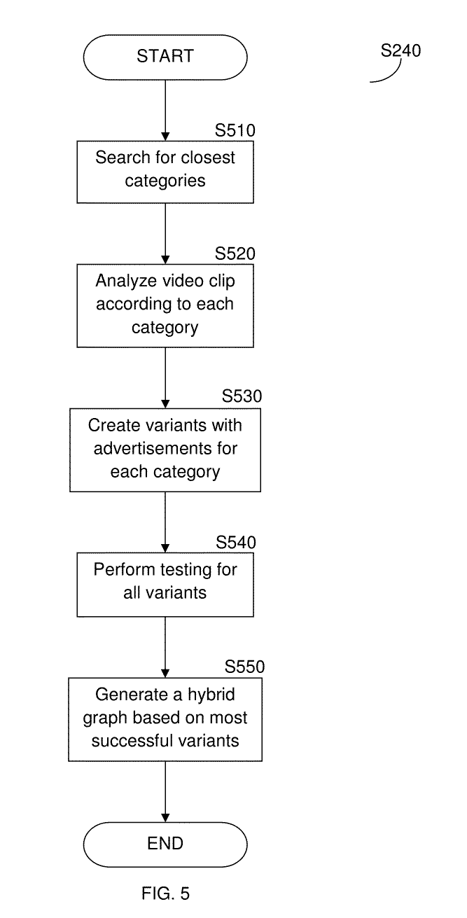

In S240, focus rules may be generated for the category and execution continues with S230. Generation of focus rules is described further herein below with respect to FIG. 5. In certain embodiments, the analysis performed in S240 is an off-line process in which rules are generated for a video clip encountered, for example during a crawling process.

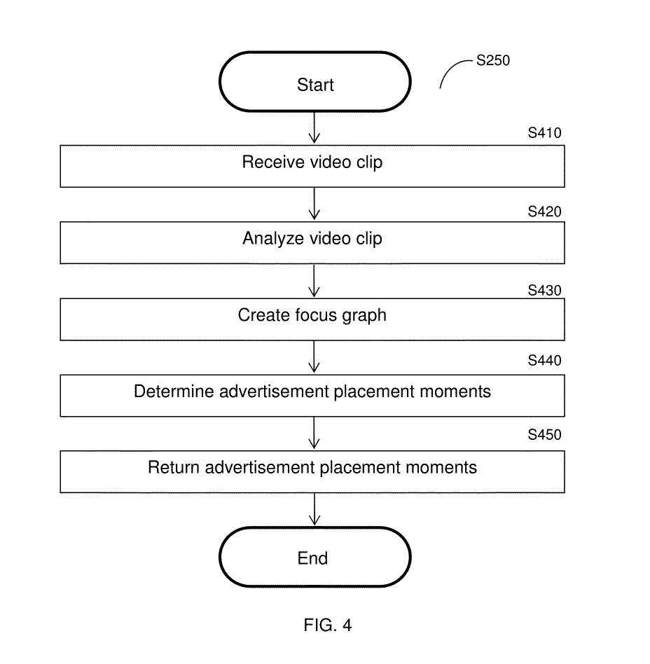

In S250, the video clip is analyzed to determining advertisement (ad) placement moments in the video clip. Determining advertisement placement moments in video clips is described further herein below with respect to FIG. 4.

The analysis is performed using the focus rules of the respective category, thereby determining one or more attention-grabbing advertisement insertion moments and/or moments for avoiding placement of the advertisement. The analysis may include determining cognitively significant moments in the video clip. An advertisement placement moment may be, but is not limited to, a specific second or a period of time in the video. The advertisement placement moment defines when the advertisement first appears to the viewer in accordance with, e.g., the appearance method. The advertisement, once appearing to the viewer, may remain displayed for a predefined time interval.

In an embodiment, metadata associated with each moment identified in the video clip may be determined. In a further embodiment, the advertisement placement moments may be determined based on the determined metadata. The metadata may indicate, but is not limited to, a filter type, a direction of movement, matching colors, contrasting colors, predicted state of mind (e.g., uninterested, highly emotional, completion-oriented, dropping, etc.), a priority ranking for the moment, historical click propensities associated with the moment, historical hover propensities associated with the moment, a tag associated with subject matter of the moment, and the like. Alternatively or collectively, the advertisement placement moments may be based on the attrition graph, focus graph, and/or category focus rules. The focus rules may indicate metadata associated with moments of cognitive significance (i.e., particularly high or low focus).

In certain embodiments, the analysis performed in S250 is an off-line process in which rules are generated for a video clip encountered, for example, during a crawling process.

In S260, advertisements are optimized based on the cognitively significant moments in the video clip. It should be noted that one or more advertisements may be associated with the video clip and activated respective thereto at the same or at different points in time during the display of the video clip. Advertisement optimization may include, but is not limited to, ensuring that multiple simultaneous advertisements do not conflict with each other, providing the advertisements during appropriate time intervals, and so on. In an embodiment, the optimization may include customizing the appearance of the advertisement and/or determining nudge moments for the advertisement, as discussed in detail herein above. The customization and/or nudge moment determination may be further based on the determined metadata.

In an embodiment, one or more advertisements from a plurality of advertisements are selected for use with respect to the video clip. In another embodiment, the return-on-investment (ROI) of each advertisement may be determined, and those advertisements providing a ROI above a predetermined threshold are selected for insertion into the video clip.

In S265, the optimized advertisements may be sent for placement. The optimized advertisements can be sent for placement during a current video clip display (e.g., to a publisher server, an ad-server, a user device, and so on). In an embodiment, S265 includes pre-selection of advertisements for the determined insertion moments. The pre-selected advertisements may be subsequently retrieved during displays of a respective video clip on a user device. The placement of the advertisement may be based on a placement and/or an appearance method defined for the advertisements.

In S270, interactions of the viewers with the inserted advertisements are captured and analyzed. In an embodiment, web browsers displaying the inserted advertisements may be caused to gather and send the interactions to, for example, the optimization server. It should be noted that the interaction information may be related to any displayed advertisement, and typically defines any action or user gesture with respect to the advertisement. This information may be utilized to optimize the process of creating category rules and/or determining cognitively uninteresting moments of the same or similar video clips for other viewers.

In an embodiment, S270 may further include determining, based on the cognitively significant moments and/or viewer interactions, one or more advertisement quality scores for the video. The advertisement quality scores may indicate, but are not limited to, a number of cognitively significant moments, a number of cognitively significant moments per type of cognitive significance, a click propensity respective of the video clip, a hover propensity respective of the video clip, an expected abandonment time of the video clip, combinations thereof, and the like.

In another embodiment, S270 may further include updating the metadata associated with moments in the video clip based on the viewer interactions. The updating may include revising and/or adding metadata indicating viewer interactions at particular moments. For example, a moment in which viewers often interacted with the advertisements inserted into the video clip may be identified as a stimulus seeking moment, and metadata indicating this identified type may be added.

It should be noted that the steps of the method described herein above with respect to FIG. 2 are described with respect to particular systems and at particular times merely for simplicity purposes and without limitation on the disclosed embodiments. In particular, placement of advertisements may be determined by an optimization server, by a user device, or by any other system (e.g., an ad-server) causing placement of the advertisement in a video clip. Additionally, the advertisement optimization, including advertisement customization and/or determination of placement, may be performed in real-time based on a currently displayed video clip, or may be performed prior to display of the video clip.

For example, the determination of advertisement placement moments may be performed completely off-line on video clips stored in a data warehouse. The determined moments may be saved in a database and communicated to a user device upon a request to serve advertisements with respect to a particular video clip. That is, an optimization server (e.g., the optimization server 170) may be called upon to provide the advertisement placement moments to the user device when advertisements to be served are requested. Alternatively, the advertisement placement moments may be communicated to the ad-serving system.

In yet another embodiment, the video clip can be processed in real-time (i.e., when uploaded on a user device) by the user device and/or the optimization server 170.

FIG. 3 shows an exemplary and non-limiting viewer attrition graph 300 for an exemplary video clip category, in this case a vehicle critique video clip. The viewer attrition graph 300 includes a data curve 310 illustrating a percentage of viewers watching a video clip over time. As can be seen, roughly 80% of the initial number of viewers continue to watch the video clip after the first five seconds of the video clip, and within 30 seconds only 60% of the initial number of viewers continue to watch the video clip. However, beyond 50 seconds, the attrition rate decreases such that around 40% of the viewers shall remain until the end of the video clip.

The data curve and associated attrition rates can be used to determine an appropriate placement of various advertisements and to optimize the search for cognitively significant moments. For example, the search for cognitively significant moments beyond the 50 second mark of the clip may not be efficient because fewer users may view the advertised content after, e.g., 30 seconds into the video clip. On the other end, a search for cognitively significant moments within the first 30 seconds is more efficient because viewers are more likely to view the contents within 30 seconds of the beginning of the video clip then later on in the video clip. Accordingly, based on the viewer attrition graph 300, it may be determined that only the first 30 seconds of the video should be analyzed to find cognitively significant moments.

Therefore, according to an embodiment, a focus or attention graph is also prepared (not shown) plotting the clicking or other interaction potential over time. It should be noted that the focus graph provides the segments of time during the clip in which a higher percentage of viewers will likely view the advertised content. It should be further noted that searches for cognitively significant moments are in these segments. For example, if viewers skipped through the first 60 seconds of the video in previous viewings, the focus graph will not include this segment and no search for cognitively significant moments will be performed in this segment.

In an embodiment, the viewer attrition graph is generated by collecting, for each video clip and for each viewer, time samples during which the viewer indicated interest or disinterest in the video by, e.g., skipping through the video, pausing the video, or stopping the video, scrolling down in a web page, allowing the video to play while not in view, scrolling back to the video (i.e., such that a video that is not in view becomes in view), and the like. Such information can be collected by the web browser or by querying the player. The samples are aggregated across multiple viewers watching the same video. Then, the segments (time periods) during which the viewers did not watch the video are computed and plotted as a graph. As new samples are received, the segments may be re-computed.

In one embodiment, when the number of received samples is low (or samples are not available yet), a predictive viewer attrition graph is utilized. That is, segments with low attrition rates from a similar video clip may be used. Video clips may be similar if, e.g., the video clips are from the same category or otherwise contain related subject matter. For example, two video clips showing highlights of different basketball games may be considered similar. The predictive segments may be updated in real-time as samples from the current video clip being analyzed are received, thereby yielding the correct low attrition segments of the video.

FIG. 4 shows an exemplary and non-limiting flowchart S250 illustrating a method for determining advertisement placement moments according to an embodiment. The method may be performed by a server (e.g., the optimization server 170). Alternatively or collectively, the method may be performed by a user device (e.g., the user device 120) based on a displayed video.

In S410, a particular video clip to be analyzed is received. In S420, the received video clip is analyzed. Analysis of a video clip may include consideration of video features such as, but not limited to, attrition rates, significant audio and visual transitions, category focus rules, and other features of a video related to cognitively significant moments as described further herein above with respect to FIG. 2. The attrition rates may be determined by processing the viewing patterns of many viewers for the same video clip.

In one embodiment, only video clips that have been actually viewed by the viewers are analyzed. In such an embodiment, for the first viewer, the cognitively significant moments are randomly determined, but for any subsequent viewers, these moments are determined using the embodiments discussed herein.

In S430, respective of the analysis, a focus graph is created for the video clip. The focus graph indicates portions of the video clip in which users are more likely to be paying attention. As a non-limiting example, the focus graph will not include segments in which the attrition rate for the clip is low. An attrition rate may be determined to be low if, e.g., the attrition rate is below a predefined threshold.

In S440, based on the video clip's focus graph and the category focus rules, advertisement placement moments are determined. In an embodiment, S440 may further include identifying cognitively significant moments in the video clip and selecting the determined advertisement placement moments from among the identified cognitively significant moments. In an embodiment, the determination is further based on feedback received with respect to interaction of advertisements previously placed for the same video clip (for different viewers). In an embodiment, when a specific advertisement placement moment cannot be determined, a suspicious segment is determined. The suspicious segment is analyzed by, for example, statistically exploring points with live viewers, running random searches for benchmarks, and using machine learning techniques.

In some embodiments, the analysis of suspicious segments may be performed only for video clips with a low number of viewers. For “viral” clips or clips with a high number of concurrent or near-concurrent viewers, such an analysis is not performed because interaction information and viewing patterns can be received and analyzed. As noted above, when the viewer attrition graph is not available, a predictive graph for a similar video may be utilized as well.

In S450, the determined advertisement placement moments are returned. It should be noted an attention-grabbing advertisement insertion moment may be a specific moment during the clip (e.g., second 27 of the video clip) or a time interval (e.g., seconds 27-30 of the video clip).

It should be noted that the advertisement placement moments, the focus graphs, the attrition graphs, and/or the hybrid graphs are always updated as new samples are received and/or using any machine learning processes fed with the determined advertisement insertion moments, gathered analytics, a random data set, and so on. The machine learning processes can be utilized to predicate video clips that have not yet been analyzed.

FIG. 5 depicts an exemplary and non-limiting flowchart S240 illustrating a method for generating category focus rules for an identified category according to an embodiment. Generation of category focus rules may be appropriate where, for example, a recognized category that lacks focus rules is identified, or where an as-of-yet unrecognized category is identified. In such a case, an attempt is made to analyze the video clip and/or the category based on sets of rules of other categories determined to be similar and having a known set of rules. The likes of genetic optimization with SWARM optimization, which would be known to a person skilled in the art, can be used to create the set of rules for the video clip and/or the category.

According to an embodiment, a baseline may be measured so as to determine the success rate of the set of rules in comparison to the success rate of other sets of rules. As a non-limiting example, a baseline of 50% of the initial number of viewers may be set as a successful number of views such that sets of rules tending to yield more than 50% of the initial number of viewers may be determined to be successful.

In S510, a search is performed to determine one or more of the categories closest to the identified category. The determination of close categories may be based on matching between the identified category and a plurality of categories associated with existing sets of focus rules. The category matching may include comparing video clips of the identified category with video clips of the categories having existing focus rules. Comparing video clips may include, but is not limited to, comparing file names, metadata, audio, and/or video content contained therein. For example, an identified category may be matched to the category “basketball videos” when matching between videos of the categories indicate that the videos are associated with file names including the word “basketball” as well as metadata related to “basketball” and “sports.”

In S520, the video clip is analyzed using the focus rules of each determined closest category. In an embodiment, S520 may further include retrieving the focus rules of each determined category. The focus rules may indicate typical transitions or other video features associated with increased or decreased user attention. Analysis of video clips is described further herein above with respect to FIG. 4.

In S530, variants of the video clip having different placements of advertisements are created respective of each set of focus rules of the categories used in the analysis. As an example, a first set of focus rules for a first category may indicate that placements of advertisements immediately before a fade out tend to be more successful, while a second set of focus rules for a second category may indicate that placements of advertisements immediately after a musical sequence tend to be more successful. Accordingly, a first variant featuring an advertisement displayed immediately before the video clip fades out and a second variant featuring an advertisement displayed immediately after a musical audio portion of the video clip may be created.

In S540, multivariate testing is performed on all of the variants. A multivariate, split or A/B test (hereinafter “multivariate test”) is a form of statistical hypothesis testing featuring a randomized experiment involving two or more different variants. Such a multivariate test may be used to, for example, compare the result of applying specific focus testing rules to the identified category to a baseline to determine the successfulness of the applied focus testing rules. The multivariate testing may be applied in real-time to advertisements in video clips viewed by users to gain information regarding the actual effect of the advertisement customization on advertisement success rates.

In S550, a hybrid graph is generated based on the most successful variants. In an embodiment, the generated graph is used as the basis of the focus rules for the video clip and/or the category. The hybrid graph may demonstrate, for example, the effects of certain focus testing rules on viewership during various times of the video clip. Thus, the generated hybrid graph may be used to determine the most appropriate focus testing rules for a particular category including the video clip. As an example, if viewership dropped by 20% when an advertisement is displayed within 5 seconds of the video clip beginning, but remained at the same level when an advertisement is displayed after an opening musical sequence (i.e., a theme song), it may be determined that the after-opening focus rule may be more appropriate for the video clip and/or for the category of the video clip.

It should be noted that the embodiments described herein above are discussed with respect to video clips merely for simplicity purposes and without limitation on the disclosed embodiments. Web objects featuring other media content such as, but not limited to, audio, images, and so on, may be utilized without departing from the scope of the disclosure. It should further be noted that the embodiments described herein above are discussed with respect to advertisements merely for simplicity purposes and without limitation on the disclosed embodiments. Other content to be displayed within a web object may be placed therein without departing from the scope of the disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for optimizing content to be inserted into a web object, comprising:
receiving an identifier associated with the web object;
determining a category of the web object;
identifying focus rules respective of the determined category, wherein the focus rules indicate characteristics of the web object related to cognitive interest;
analyzing, based in part on the focus rules, the web object;
determining, based on the analysis, a content placement moment in the web object; and
causing a placement of the content in the web object at the content placement moment.

2. The method of claim 1, further comprising:
generating, based on the analysis, a focus graph of the web object, wherein the focus graph indicates cognitive interest for the web object.

3. The method of claim 2, wherein the focus graph is generated based on attrition rates of a plurality of users associated with the web object.

4. The method of claim 1, further comprising:
determining metadata associated with at least a portion of the web object, wherein the content placement moment is determined further based on the metadata.

5. The method of claim 1, further comprising:
capturing at least one user interaction with the web object including the placed content; and
analyzing the captured at least one user interaction.

6. The method of claim 5, further comprising:
determining at least one advertisement quality score based on any of: the analysis of the web object, and the analysis of the captured at least one user interaction.

7. The method of claim 1, wherein determining the content placement moment in the web object further comprises:
determining, based on the analysis, at least one cognitively uninteresting moment in the web object; and
selecting the content placement moment from the at least one cognitively uninteresting moment.

8. The method of claim 1, further comprising:
customizing, based on the analysis, an appearance method for the content.

9. The method of claim 1, further comprising:
determining, based on the analysis, at least one nudge moment; and
customizing the content based on the at least one nudge moment, wherein the customized content is animated at the at least one nudge moment.

10. A non-transitory computer readable medium having stored thereon instructions for causing one or more processing units to execute the method according to claim 1.

11. A system for optimizing content based on focus data, comprising:
a processing unit; and
a memory, the memory containing instructions that, when executed by the processing unit, configure the system to:
receive an identifier associated with the web object;
determine a category of the web object;
identify focus rules respective of the determined category, wherein the focus rules indicate characteristics of the web object related to cognitive interest;
analyze, based in part on the focus rules, the web object;
determine, based on the analysis, a content placement moment in the web object; and
cause a placement of the content in the web object at the content placement moment.

12. The system of claim 11, wherein the system is further configured to:
generate, based on the analysis, a focus graph of the web object, wherein the focus graph indicates cognitive interest for the web object.

13. The system of claim 12, wherein the focus graph is generated based on attrition rates of a plurality of users associated with the web object.

14. The system of claim 11, wherein the system is further configured to:
determine metadata associated with at least a portion of the web object, wherein the content placement moment is determined further based on the metadata.

15. The system of claim 11, wherein the system is further configured to:
capture at least one user interaction with the web object including the placed content; and
analyze the captured at least one user interaction.

16. The system of claim 15, wherein the system is further configured to:
determine at least one advertisement quality score based on any of: the analysis of the web object, and the analysis of the captured at least one user interaction.

17. The system of claim 11, wherein the system is further configured to:
determine, based on the analysis, at least one cognitively uninteresting moment in the web object; and
select the content placement moment from the at least one cognitively uninteresting moment.

18. The system of claim 11, wherein the system is further configured to:
customize, based on the analysis, an appearance method for the content.

19. The system of claim 11, wherein the system is further configured to:
determine, based on the analysis, at least one nudge moment; and
customize the content based on the at least one nudge moment, wherein the customized content is animated at the at least one nudge moment.
